(19) United States
(12) Patent Application Publication
(10) Pub. No.: US 2024/0346175 A1
(43) Pub. Date: Oct. 17, 2024

(54) METHODS AND SYSTEMS FOR SHARING PRIVATE DATA

(71) Applicant: Adeia Guides Inc., San Jose, CA (US)

(72) Inventors: Gyanveer Singh, Bangalore (IN); Reda Harb, Issaquah, WA (US); Dhananjay Lal, Englewood, CO (US)

(21) Appl. No.: 18/135,582

(22) Filed: Apr. 17, 2023

(51) Int. Cl. G06F 21/62; G06F 16/63; G10L 15/18; G10L 15/22; G10L 15/30

(52) U.S. Cl. CPC G06F 21/6245; G06F 16/63; G10L 15/1815; G10L 15/22; G10L 15/30

(57) ABSTRACT

Systems and methods are described for receiving a voice query at a virtual assistant cloud service through a first communication channel, determining an intent of the voice query at the virtual assistant cloud service, selecting an application to resolve the intent of the voice query, and determining whether private data is required to resolve the intent of the voice query. Where private data is required to resolve the intent of the voice query, a second communication channel is established for receiving the private data at the application.

### BACKGROUND

The present disclosure relates to methods and systems for sharing private data. Particularly, but not exclusively, the present disclosure relates to methods and systems for sharing private data during a communication session between a user and a virtual assistant.

### SUMMARY

In the past, users have typically interacted with digital systems using interfaces such as graphical user interfaces (GUI), number pads, and keyboards. It is becoming increasingly common for users to interact with digital services through voice interactions using a virtual assistant (VA). In order to process a user's voice interactions, speech is typically sent to virtual assistant cloud services which perform automatic speech recognition and natural language processing in order to determine the user's intent, for example, what they would like to be achieved by the VA, and to utilise an appropriate program, or application, to perform the necessary actions to achieve that goal. Virtual assistants can be used for a range of activities such as checking a fact, giving instructions to internet of things (IoT) devices, booking a ticket or hotel, media control, etc. In some cases, voice interactions with virtual assistants are used to perform transactions such as payments, arrange hospital appointments, and use banking services. During such interactions, it may be necessary for a user to provide sensitive, or private, information. However, this increases the compliance burden relating to handling private data for the VA cloud services. Additionally, a user may not feel comfortable sharing private information through a VA.

Systems and methods are provided herein for reducing a compliance burden on handling private data by VA cloud services, and additionally may improve a user's privacy by reducing the exposure of private information to VA cloud services. For example, the methods and systems herein may provide a second communication channel for receiving private data at an application which requires the private data to fulfil an intent of a voice query of user, as opposed to using a first communication channel which involves a virtual assistant cloud service. In some examples, the second communication channel may bypass the virtual assistant cloud service.

According to the systems and methods described herein, a voice query at a virtual assistant cloud service is received through a first communication channel. For example, a user may interact with a virtual assistant provided, for example, in a client device, to provide a voice query. A query may be any of a request, question and command. The first communication channel may be a channel between any of the virtual assistant cloud services, a virtual assistant associated with the virtual cloud services, a client device associated with the virtual assistant, and an application. For example, the application maybe a conversational application (the terms “application” and “conversational applications” may be interchangeable herein), which may receive and respond to voice queries from a user. An intent of the voice query is determined at the virtual assistant cloud service. For example, the virtual assistant cloud service may make use of language processing functions, such as automatic speech recognition (ASR), natural language understanding (NLU)-Intent determination, and/or text-to-speech (TTS) functions, in order to determine the intent of the voice query. An application to resolve the intent of the voice query is selected. For example, an application which is able to address the voice query may be selected (e.g., the application may be able to perform functions desired by the user as indicated by their voice query). The application may be a conversational application, or a “skill”. It is then determined whether private data is required to resolve the intent of the voice query. For example, the user may be required to provide additional private information in order that the application is able to fulfil the user's intent. Certain data may be predetermined as being private data, such as health records, passport number, etc. Where private data is required to resolve the intent of the voice query, a second communication channel for receiving the private data is established. For example, the second communication channel may be different to the first communication channel. The second communication channel may provide a channel of communication between a subset of the components communicably connected in the first communication channel. The second communication channel may be for receiving the private data at the application.

In some examples, the second communication channel may bypass the virtual assistant cloud service. For example, the second communication channel may not include, or may exclude, the virtual assistant cloud services.

In some examples, the second communication channel may be established based on a bypass signal generated by the application or by the virtual assistant cloud service, or based on a user initiated bypass signal. For example, the bypass signal may be a system generated bypass signal (e.g. the system may comprise the application and the virtual assistant cloud service, and in some examples, may comprise a privacy system which may generate the bypass signal). The system may determine that private data is required and consequently generate a bypass signal. The bypass signal may be generated in response to a user indicating that the information they are to share is private data (e.g. data that they do not want to share). For example, the indication may be a verbal trigger word, or may be received by an interaction of a user with a graphical user interface (GUI) in an application on a client device.

In some examples, the second communication channel may comprise a path between (for example, directly between): a first device comprising a virtual assistant associated with the virtual assistant cloud service, or a second device; and at least one of: the application, a further application associated with the application, a website interface, and an interactive voice response. For example, the first device may be a mobile phone comprising a virtual assistant, where when private data is to be shared, an application on the mobile device may be used to collect the private data. In another example, where the virtual assistant is provided on a first device such as a smart speaker, the private information may be provided using a second device such as a mobile phone. For example, the application which is configured to resolve the intent of the voice query may utilise a further application associated with the application in order to collect the private data. An example of a further application is a banking application on a mobile phone, where the application is a shopping application. For example, where a user's voice query indicates that they would like to purchase an item, the application may require a user to utilise a banking application in order to allow the application to access payment information.

In some examples, the second communication channel may be an encrypted communication channel. For example, the second communication channel may be encrypted between a client device and the application. The encryption may utilize public-key encryption.

In some examples, the pathway of the second communication channel may be dependent on the type of private data. For example, the pathway of the second communication channel may be to a first device (such as a mobile phone) if the private data relates to medical data, and the pathway may be to a second device (such as a tablet) if the private data relates to financial data. The pathway may depend on which device an application associated with the application is installed on. Categories of types of private data may be predetermined.

In some examples, the determination that private data is required may be made based on a determination that a query (e.g. to be sent to a user or client device) generated by the application is a private information query, e.g., where private information will be required in order to answer the query. For example, the virtual assistant cloud service may determine that a query generated by the application to be sent to a user is a private information query. For example, the application may determine that a query it has generated and is to be sent to a user is a private information query. In some examples, the determination that private data is required is made based on a determination that the voice query indicates that private data is required. For example, the voice query may request a function from an application that requires the use of private data, such as “Arrange a doctor's appointment”. In some examples, the determination that private data is required is made based on receiving an indication from a client device that private data is required. For example, a user may indicate via a client device that they want subsequently shared information to be considered to be private data.

In some examples, private data may be received at the application via the second communication channel. For example, private data may be received directly at the application from a client device with which a user is interacting.

In some examples, the first communication channel may be reverted to once the receiving of private data is concluded. For example, the system may switch back to the first communication channel for communication between the user and the application, or VA cloud services. For example, the second communication channel may be used only while private data is collected. Once the private data has been collected, the communication path (e.g. between the application and the user, or client device) may revert to the first communication channel. In some examples, the first communication channel is reverted to once a predetermined time period has elapsed. For example, where no private data is received after a predetermined time period after the second communication channel has been established, the connection may time-out. Ongoing communication may then be performed using the first communication channel.

In some examples, an alert may be generated if a query generated by the application requires more private data than is typically required to achieve the intent of the voice query. An intent of a voice query is considered to be achieved, for example, where the user has requested some action to be performed, and that action has been completed, and/or where an action it is understood that the user has requested (implied or otherwise) is completed, and/or where an action required to address the voice query of a user has been completed. Data may be available on the type and amount of information that would usually be requested by a particular type of application in order to achieve an intent of a user. By comparing the information required by the query with available data on typical queries, it may be determined whether the amount of private data requested is appropriate. If it is determined that the application requires more private data than is typically required to achieve the intent of the voice query, the communication channel may also revert to the first communication channel. The alert may indicate to a user that too much private data has been requested. The alert may be generated by the VA cloud services. For example, while communication is performed through the second communication channel in order that the user can provide private information directly to the application, the VA cloud services may receive the application query that is being presented to the user. The VA cloud services may therefore use the application query to determine if more private data than is typically required has been requested of the user.

According to the systems and methods described herein, during a communication session between a user and an application performed through a first communication channel (e.g., involving a virtual assistant and virtual assistant cloud services), in response to determining that private data is to be shared by a user, an alternative communication channel may be enabled for the user to share the private data (e.g., an alternative communication channel that bypasses the virtual assistant cloud services).

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an overview of the system for sharing private data, in accordance with some examples of the disclosure;

FIG. 2 is a block diagram showing components of an example system for sharing private data, in accordance with some examples of the disclosure;

FIG. 3 is a flowchart representing a process for sharing private data, in accordance with some examples of the disclosure;

FIGS. 4A and 4B show a flowchart representing a process for sharing private data, in accordance with some examples of the disclosure;

FIG. 5 is a block diagram showing components of an example system for sharing private data, in accordance with some examples of the disclosure; and

FIGS. 6A-6C illustrate application interfaces, in accordance with some examples of the disclosure.

### DETAILED DESCRIPTION

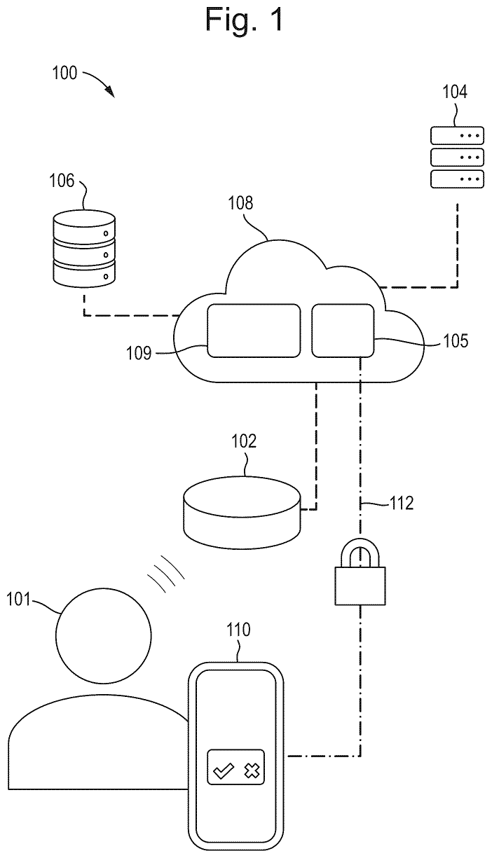

FIG. 1 illustrates an overview of a system 100 for processing voice queries of a user 101. In particular, the example shown in FIG. 1 illustrates a user 101 verbally interacting with a client device 102 (e.g. a first device) comprising a virtual assistant (VA). For the avoidance of doubt, a virtual assistant is a software agent that can perform tasks or services for a user based on commands or questions, where a virtual assistant may typically operate in conjunction with virtual assistant cloud services, and in some cases further applications such as third party applications, in order to perform the tasks or services. Herein, a virtual assistant may receive commands or questions from a user, and verbally respond to a user, where the commands or questions may be processed by the virtual assistant cloud services. The client device 102 may comprise a microphone for receiving voice input, and a speaker for providing voice output. The client device 102 may comprise control circuitry. The client device 102 may be an electronic device such as a smart speaker, a wearable device, a mobile phone, a tablet or a computer (such as a laptop). The client device 102 may be communicatively coupled to a server 104 and a content item database 106, e.g., via network 108. The user 101 may additionally interact with a further client device (a second device 110). The second device 110 may be an electronic device such as a wearable device, a mobile phone, a tablet, or a computer (such as a laptop). The second device 110 may comprise an interface through which the user 101 can enter information. For example, the second device 110 may comprise a touch screen, a keyboard, a mouse, a microphone, or any combination thereof.

The network 108 of this example may operate in conjunction with a server 104 and a content database 106, where the client device 102 is communicatively coupled to the database 106 and the server 104 via the network 108. The network 108 of this example comprises a virtual assistant (VA) cloud service (or VA cloud services) 109 and an application 105 (will be referred to herein as a conversational application, or “skill”), which are communicatively coupled to one another. It will be appreciated that the VA cloud services 109 and the conversational application 105 may operate in conjunction with the server 104, and the content database 106. The VA cloud service 109 may comprise control circuitry, or may be operable via control circuitry. Similarly, the application 105 may comprise control circuitry, or may be operable via control circuitry.

Conversational applications may be considered to be applications which are capable of responding to particular queries raised by a user, and in particular, may be capable of responding to queries raised by a user using voice input. A user (or voice) query may be a command or a question. Different conversational applications may be used to respond to different queries, where different conversational applications may have different capabilities. As an example, conversational applications may be used to perform tasks such as checking the news, controlling cloud connected devices, and listening to music. They may also be used to arrange appointments, such as doctor's appointments, and purchase items.

In this example only one conversational application is shown, however, it will be appreciated that the system may be connected to, or comprise, any number of conversational applications performing various functions. Furthermore, the conversational application 105 is shown here as part of a cloud system comprising the VA cloud service 109, however, the conversational application 105 may equally be part of the VA cloud service 109, or in a cloud system separate to the cloud system comprising the VA cloud service 109.

In order for the user 101 to make use of the functionality of the conversational application 105, the virtual assistant cloud service 109 processes voice input received at the client device 102 in order to generate data which can be processed by the conversational application 105. For example, the VA cloud service 109 may produce raw text and an intent from the voice input of a user. The VA cloud service 109 may make use of any of automatic speech recognition (ASR), natural language understanding (NLU)-Intent determination, and/or text-to-speech (TTS) functions. The VA cloud service 109 may comprise an automatic speech recognition (ASR) module, a natural language understanding (NLU)-Intent determination module, and/or a text-to-speech (TTS) module. In this manner, the client device 102 may pass voice input of a user through a system which is capable of processing and responding to verbal queries issued by the user 101.

For example, the user 101 may verbally present voice input, such as a voice query, to the client device 102. The client device 102, e.g., the virtual assistant of the client device, receives the voice input and passes the voice input to the network 108. The VA cloud services of the network 108 may perform ASR to convert the voice input into text, NLU analysis on the text to determine the user's intent, and select a conversational application 105 related to the user intent, which should be capable of resolving the intent of the user's query. The voice input may be passed to the selected conversational application 105, or the voice input may be processed before being passed to the conversational application 105.

In some cases, private data may be required in order to fulfil the user's intent. For example, it may be necessary for the application to receive from the user private information in order that the functionality requested by the user can be performed. In some examples, it may be determined that the initial voice query indicates that private data will be required. This may be determined by the VA cloud services 109, or by the conversational application 105. In some examples, the user 101 may provide an indication that their voice query will require follow-up private data. For example, the user 101 may provide a predetermined command or keyword to the client device 102 indicating that subsequent communication should be considered to contain private information. Alternatively or additionally, the user 101 may interact with a user interface, for example, a user interface provided at a second device 110, indicating that subsequent communication should be considered to contain private information.

The conversational application 105 may determine that additional information is needed from the user 101 to fulfil the user's intent, and the conversational application 105 may generate their own application queries (which may also be termed response queries) to be presented to the user 101 in order to gather the relevant information. The queries may be passed through the VA cloud services 109 to the user 101, where the query may be presented as speech to the user. The application query generated by the conversational application 105 may be used to determine whether private data is required to resolve the intent of the voice query. For example, the VA cloud services may analyze the application query to determine whether the query is a private information query, e.g., where private information will be provided in response to the query, and thus whether private data will be required to resolve the intent of the voice query. Alternatively or additionally, the conversational application 105 itself may determine that the query it has generated, and will present to the user 101, is a private information query. Alternatively or additionally, the user 101 may determine that the information to be shared in response to an application query is private data, and may indicate this in some manner to the system, such as by using a predetermined voice command.

The communication between the client device 102, the VA cloud services 109, and the conversational application 105 may be considered to be through a first communication channel. Where it has been determined that private data is required to resolve the intent of the voice query, a second communication channel 112 is established for receiving the private data at the conversational application 105. The second communication channel 112 may be between a second device 110, such as a mobile phone, and the conversational application 105, as is shown in FIG. 1. The second communication channel 112 may bypass the VA cloud service 109. For example, the second communication channel 112 may be directly between the conversational application 105 and the second device 110. The second communication channel 112 may also be encrypted in order to provide further security measures for the communication between the conversational application 105 and the second device 110. The conversational application 105 may use a further application associated with the conversational application 105, a website interface, or an interactive voice response system with which the user 101 may interact (for example, through the second device) in order to collect the private data.

In another example, the second communication channel may be between the client device 102 and the conversational application 105, for example where the first communication channel is between a virtual assistant provided in the client device 102 and the conversational application 105, and the second communication channel is between an application provided in the client device 102 and the conversational application 105. In this case, the second communication channel may be directly between the conversational application 105 and the client device 102. As in the previous example, the second communication channel may not include the VA cloud service 109.

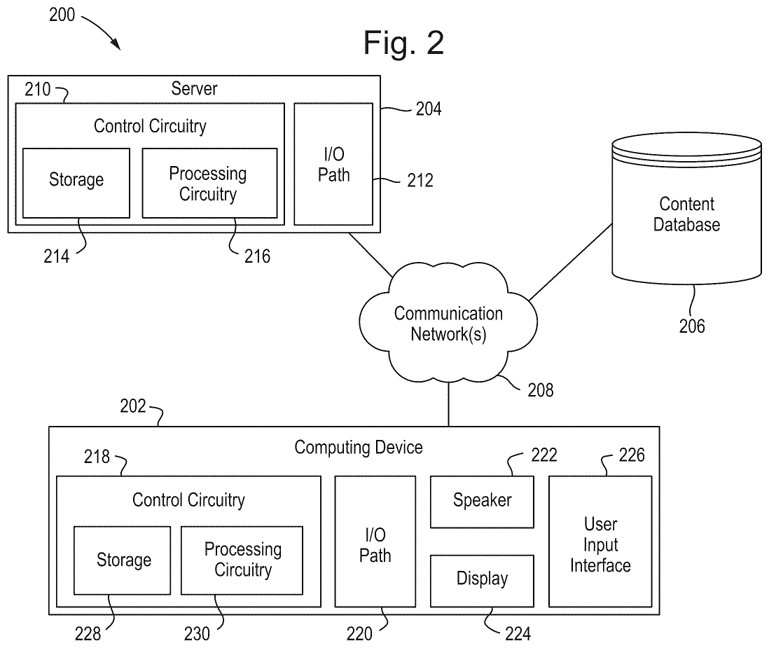

FIG. 2 is an illustrative block diagram showing example system 200, e.g., a non-transitory computer-readable medium, configured to process voice input of a user. Although FIG. 2 shows system 200 as including a number and configuration of individual components, in some examples, any number of the components of system 200 may be combined and/or integrated as one device, e.g., as user device 102. System 200 includes computing device n-202 (denoting any appropriate number of computing devices, such as user device 102 and/or device 110), server n-204 (denoting any appropriate number of servers, such as server 104), and one or more content databases n-206 (denoting any appropriate number of content databases, such as content database 106), each of which is communicatively coupled to communication network 208, which may be the Internet or any other suitable network or group of networks, such as network 108. In some examples, system 200 excludes server n-204, and functionality that would otherwise be implemented by server n-204 is instead implemented by other components of system 200, such as computing device n-202. For example, computing device n-202 may implement some or all of the functionality of server n-204, allowing computing device n-202 to communicate directly with content database n-206. In still other examples, server n-204 works in conjunction with computing device n-202 to implement certain functionality described herein in a distributed or cooperative manner.

Server n-204 includes control circuitry 210 and input/output (hereinafter “I/O”) path 212, and control circuitry 210 includes storage 214 and processing circuitry 216. Computing device n-202, which may be an HMD, a personal computer, a laptop computer, a tablet computer, a smartphone, a smart television, or any other type of computing device, includes control circuitry 218, I/O path 220, speaker 222, display 224, and user input interface 226. Control circuitry 218 includes storage 228 and processing circuitry 220. Control circuitry 210 and/or 218 may be based on any suitable processing circuitry such as processing circuitry 216 and/or 230. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 214, 228, and/or storages of other components of system 200 (e.g., storages of content database 206, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 214, 228, and/or storages of other components of system 200 may be used to store various types of content, metadata, and or other types of data. Non-volatile memory may also be used (e.g., to launch a boot-up routine and other instructions). Cloud-based storage may be used to supplement storages 214, 228 or instead of storages 214, 228. In some examples, control circuitry 210 and/or 218 executes instructions for an application (for example, a virtual cloud service, a conversational application, an application associated with the conversational application, TTS, NLU-Intent Determination, ASR etc.) stored in memory (e.g., storage 214 and/or 228). Specifically, control circuitry 210 and/or 218 may be instructed by the application to perform the functions discussed herein. In some implementations, any action performed by control circuitry 210 and/or 218 may be based on instructions received from the application. For example, the application may be implemented as software or a set of executable instructions that may be stored in storage 214 and/or 228 and executed by control circuitry 210 and/or 218. In some examples, the application may be a client/server application where only a client application resides on computing device n-202, and a server application resides on server n-204.

The application may be implemented using any suitable architecture. For example, it may be a stand-alone application wholly implemented on computing device n-202. In such an approach, instructions for the application are stored locally (e.g., in storage 228), and data for use by the application is downloaded on a periodic basis (e.g., from an out-of-band feed, from an Internet resource, or using another suitable approach). Control circuitry 218 may retrieve instructions for the application from storage 228 and process the instructions to perform the functionality described herein. Based on the processed instructions, control circuitry 218 may determine what action to perform when input is received from user input interface 226.

In client/server-based examples, control circuitry 218 may include communication circuitry suitable for communicating with an application server (e.g., server n-204) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 208). In another example of a client/server-based application, control circuitry 218 runs a web browser that interprets web pages provided by a remote server (e.g., server n-204). For example, the remote server may store the instructions for the application in a storage device. The remote server may process the stored instructions using circuitry (e.g., control circuitry 210) and/or generate displays. Computing device n-202 may receive the displays generated by the remote server and may display the content of the displays locally via display 224. This way, the processing of the instructions is performed remotely (e.g., by server n-204) while the resulting displays, such as the display windows described elsewhere herein, are provided locally on computing device n-202. Computing device n-202 may receive inputs from the user via input interface 226 and transmit those inputs to the remote server for processing and generating the corresponding displays.

A computing device n-202 may send instructions, e.g., to receive and/or process voice input of a user, and/or establish communication channels, to control circuitry 210 and/or 218 using user input interface 226.

User input interface 226 may be any suitable user interface, such as a remote control, trackball, keypad, keyboard, touchscreen, touchpad, stylus input, joystick, voice recognition interface, gaming controller, or other user input interfaces. User input interface 226 may be integrated with or combined with display 224, which may be a monitor, a television, a liquid crystal display (LCD), an electronic ink display, or any other equipment suitable for displaying visual images.

Server n-204 and computing device n-202 may transmit and receive content and data via I/O path 212 and 220, respectively. For instance, I/O path 212, and/or I/O path 220 may include a communication port(s) configured to transmit and/or receive (for instance to and/or from content database n-206), via communication network 208, content item identifiers, content metadata, natural language queries, and/or other data. Control circuitry 210 and/or 218 may be used to send and receive commands, requests, and other suitable data using I/O paths 212 and/or 220.

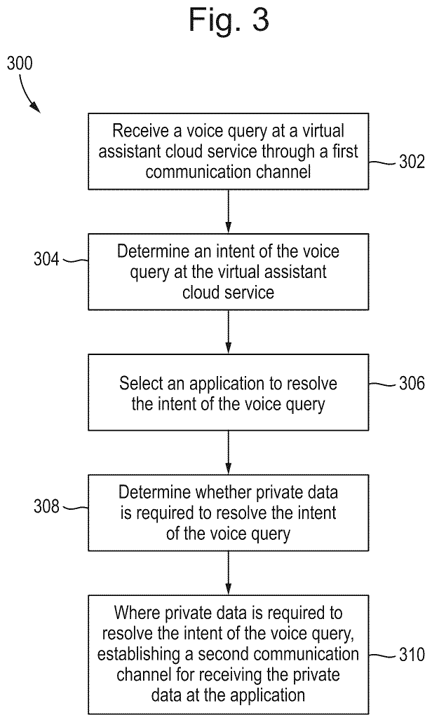

FIG. 3 shows a flowchart representing an illustrative process 300 for processing a voice query of a user. While the example shown in FIG. 3 refers to the use of system 100, as shown in FIG. 1, it will be appreciated that the illustrative process 300 shown in FIG. 3 may be implemented, in whole or in part, on system 100 and/or any other appropriately configured system architecture. For the avoidance of doubt, the term “control circuitry” used in the below description applies broadly to the control circuitry outlined above with reference to FIG. 2. For example, control circuitry may comprise control circuitry of client device 102, control circuitry relating to the VA cloud service 109, control circuitry relating to the conversational application 105, control circuitry of the client device 102, control circuitry of the second device 110, and control circuitry of server 104, working either alone or in some combination.

At 302, control circuitry, e.g., control circuitry of the VA cloud service 109, receives a voice query at a VA cloud service 109 through a first communication channel, e.g., a communication channel involving the VA cloud service 109. In the context of the present disclosure, a “query” is understood to comprise any of a request, question and command. For example, a user may provide a voice query to a virtual assistant at a client device 102, where the client device 102 may forward the voice query to the VA cloud service 109.

At 304, control circuitry, e.g., control circuitry of the VA cloud service 109, determines an intent of the voice query at the VA cloud service 109. As is outlined above in relation to FIG. 1, the VA cloud services may utilize an ASR module to perform automatic speech recognition of the voice query to generate raw text, which is then passed to an NLU-Intent determination module. The NLU-Intent determination module may then perform natural language understanding intent determination to determine the intent of the voice query.

At 306, control circuitry, e.g. control circuitry of the VA cloud service 109, selects a conversational application 105 to resolve the intent of the voice query. For example, The NLU-Intent determination module may select an appropriate conversational application to resolve the intent of the voice query based on the determined intent. The intent (and raw text) may then be sent to the conversational application 105.

At 308, control circuitry, e.g. control circuitry of the VA cloud service 109, or control circuitry of the conversational application 105, determines whether private data is required to resolve the intent of the voice query. For example, the conversational application may require additional information from the user in order to respond to the user intent. The conversational application 105 may generate an application query in response to the voice query to be sent to the user 101 in order to obtain additional information. The VA cloud service 109 or the conversational application 105 may classify the application query as either private or non-private information. Alternatively or additionally, the voice query may be assessed to determine if private data will be required in order to fulfil the user intent associated with the voice query. Alternatively or additionally, the user 101 may indicate whether subsequent voice data will include private information. For example, the user may indicated whether subsequent voice data will include private information through the use of a predetermined command or keyword spoken to a client device, or through a user interface such as a graphical user interface, for example provided at the client device or at a second device.

At 310, where private data is required to resolve the intent of the voice query, control circuitry, e.g. control circuitry, e.g. control circuitry of the VA cloud service 109, or control circuitry of the conversational application 105, establishes a second communication channel 112 for receiving the private data at the conversational application. For example, the second communication channel may bypass the VA cloud service 109. Responses to the query may be obtained at the conversational application 105 through the second communication channel 112 rather than through the first communication channel, for example, so that private data is directly shared with the conversational application rather than with the VA cloud service 109. The second communication channel 112 may be established in response to a bypass signal.

The bypass signal may be a generated bypass signal. For example, before presenting an application query to the user 101, it may be determined if the application query is a private information query. If it is determined that the application query is a private information query, the system may tag the query as a private information query and generate a bypass signal. In an example, the bypass signal can be generated by the VA cloud service 109 or by the conversational application 105. On receiving a bypass signal, the conversational application 105 may directly capture the user's response, bypassing the VA cloud service 109. The conversational application 105 may initiate, or establish, a secure communication path with a second device 110, where the private data may be received via the second device 110. Possible interfaces with which the user may interact in order that the private data is collected at the second device 110 are outlined later in the specification.

The bypass signal may be based on a user initiated bypass signal. For example, the system may allow a user 101 to trigger the bypass signal at the same time as, or before, responding to an application query. A list of bypass keyword(s)/commands may be pre-configured by the user 101 or the system 100. The bypass keyword(s)/commands may be detected either by VA cloud services 109, or by the conversational application 109. If voice input includes a bypass keyword(s)/command, the system 100 may generate a bypass signal, and send the bypass signal to the conversational application 105. The user 101 may instruct that a second communication channel 112 is to be established through voice input to the client device 102 or as input to the conversational application 105, using a predefined keyword or command. This instruction may be considered to be a bypass signal.

On receiving a bypass signal, the conversational application 105 may initiate, or establish, a secure communication session (e.g., establish the second communication channel 112) (directly) with a second device 110, where the private data may then be received through the second device 110. A notification may be sent to the user 101 through the client device 102 that private data is to be captured through a second communication channel 112 on the second device 110. The notification may also contain the identity of the second device (e.g., smartphone, tablet, etc.). The notification may be generated by the conversational application 105 or by the VA cloud services 109. The second device 110 and the conversational application 105 may use the second communication channel 112 for subsequent voice or non-voice interactions. The system may switch between the first communication path and the second communication path as required for each application generated query. The second communication channel 112 may be encrypted using a public-private key negotiated between the second device 112 and the conversational application 105. Once the second communication channel 112 has been established, all subsequent follow on questions (e.g., application queries) and follow on answers may pass through the second communication channel 112. For example, the subsequent voice and/or non-voice interaction may include private data, which the user may not want to share with the VA cloud services 109, or that the VA cloud services may not want to process. By using a different device or different type of input (e.g. using non-voice input as opposed to voice input), a user may be reassured that their private data will not be shared with the VA cloud services. Furthermore, the burden on the VA cloud services in relation to requirements relating to the processing and storing of private data is reduced.

A further application associated with the conversational application 105 may be available to the user 101 for inputting particular private data. The further application may be an application installed on a client device of a user, for example, the second device 110. The second communication channel 112 may therefore include a pathway between the further application and the conversational application 105. Any application queries, such as a private information query, may be presented, and follow up answers may be received, using the further application which may be installed on the client device 102 or the second device 110. The private information query may be to verify the user or to collect more subjective responses from the user. The system may also present the private information query on the VA client device 514, and may play a notification on the VA clients device that the response needs to be provided on the second device 518.

In an example, the second device 110 may be selected to be used in the second communication pathway based on a specific type of private information query. A second device may be considered to be a device which does not comprise the virtual assistant. The system or the conversational application may determine which user device (e.g., the second device) has the required private data, or has the means to retrieve the private data (such as a further application), and select that particular device. In an example, for sharing financial data one particular device (e.g., device-1) may be selected, for example, as the device has a banking application, and for sharing medical data a different particular device may be selected (e.g., device-2), for example, as the device has a medical application. If the client device comprising the virtual assistant has the means for retrieving the private data (e.g., has an application for receiving the particular type of private data), the client device may be selected. In this case, the explanations herein of the use of the second device also apply to the client device comprising the virtual assistant. The second device 110 may be used for presenting a follow on question to the user and receiving a follow on answer at the conversational application for fulfilling the user's intent. Users may use bypass keywords or commands to indicate a preference for using a second device for sharing private information at any time after a conversational application is selected to process the user intent.

For example, the conversational application 105 and/or the VA cloud services 109 may instruct the user to open the associated application and perform an action such as to confirm their date of birth, or the notification may be deep linked to a section within the associated application for the user to enter an answer to the application query. If the notification is authenticated, information which may be pre stored on the second device 110 (users often store information such as their blood type, address, emergency contacts, etc.) may be shared with the conversational application 105 via the associated application.

While the second communication channel is initiated with the second device 110, the client device 102 may inform the user 101 that the second communication channel 112 has been established with the second device 110 to capture private data. In an example, the conversational application 105 may send an application query to a text to speech converter of the VA cloud services 109 to be output using a second synthetic voice output (type-2), which is different to a first synthetic voice output (type-1) which is used while communicating with the user 101 through the first communication channel, for example, when presenting a non-private information query or presenting a general response. The system may play the application query using the virtual assistant of the client device 102 at the same time that the application query is presented on the second device 110. The system may output a notification on the client device 102 regarding the status (e.g., failure, success, in process) of the private data collection. Once the user has been verified by the conversational application or the required private information is received by the conversational application, the intent of the user may be resolved. In particular, the conversational application may resolve the query of the user by using the private data in order to realize the user's intent. For example, the private data may be used to perform the action which the user intended the application to perform. In an example, this may be booking a doctor's appointment, where the private data is related to the symptoms of the user. Once the symptoms have been received by the conversational application, the application may proceed to book a doctor's appointment.

Once the user's intent has been resolved, the client device 102 may output a confirmation message. For example, the client device 102 may play a notification “Thanks for sharing your details through the second device. You are successfully authenticated”, or “Thanks for sharing your details, your appointment is confirmed for 15 Apr. 2023”.

Once the required private data has been captured by the conversational application 105, the system 100 may revert to the first communication channel and route the voice input through the VA cloud services 109.

In an example, the system may also implement security control features. For example, the system may request from the conversational application 105 an estimated time at which the interaction will be handed back to the VA cloud services 109. If the interaction is not handed back to the VA cloud services 109 once the estimated time has elapsed, The VA cloud services 109 may interrupt the communication and take control. If the conversational application 105 is not able to receive the required private data from the second device 110, a time out message may be sent through the client device 102 to the user 101.

In an example, the system may prevent over collection of private data. For example, while allowing the conversational application 105 to directly present private information queries (also referred to as follow-on questions, response queries) and collect user responses to those queries relating to private data using a second device 110, the VA cloud services 109 may still want to ensure that the conversational application 105 is not over collecting private information. If the questions generated to be presented to the user 101 relate to the user intent, the VA cloud services 109 may allow direct communication of the second device 110 with the conversational application 105. In case the questions are identified to be asking more private data than is normally required to fulfil the user intent, the VA cloud services 109 may interrupt and take control back from the conversational application 105, after alerting the user. For example, the communication may revert from the second communication channel to the first communication channel.

It will be appreciated that while the VA cloud services 109 of this example receive the private information query to be presented to the user 101, the VA cloud services 109 do not receive the response of the user 101 comprising the private data.

It will be appreciated that the above example refers to a second device, where the second device forms part of the second communication channel with the conversational application. However, it will be appreciated that a device that forms part of the second communication channel may equally be the same device on which the virtual assistant is provided.

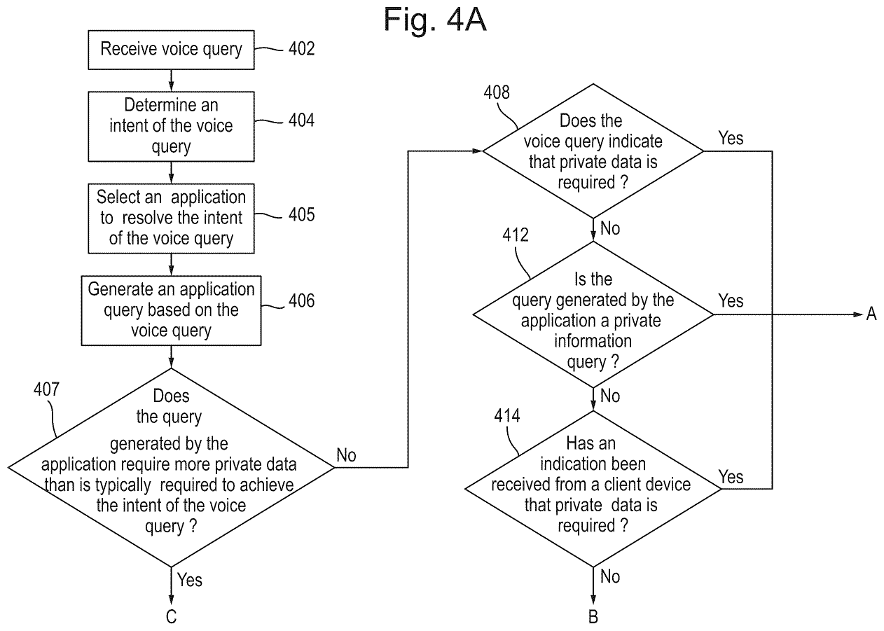

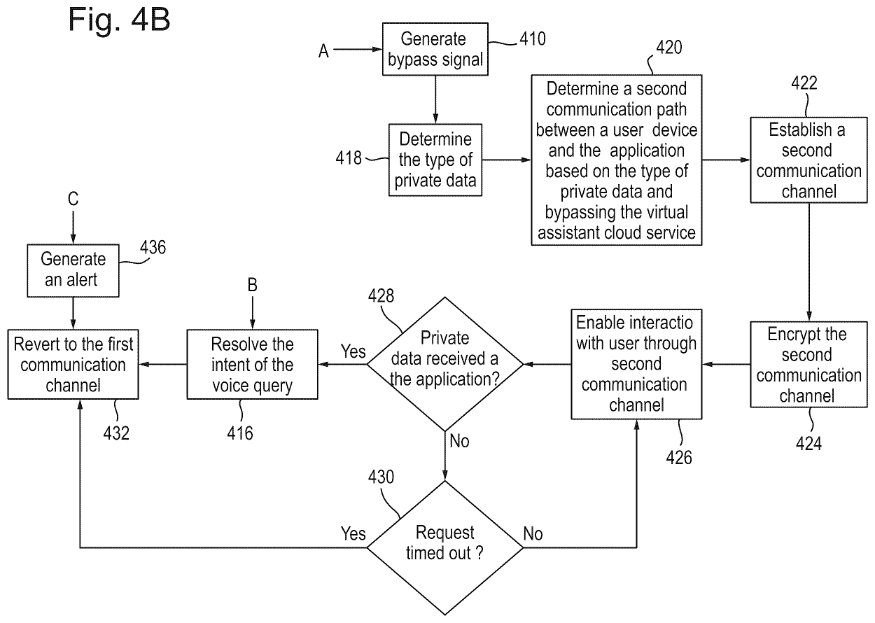

An example of processing a voice query is illustrated in FIGS. 4A and 4B. FIGS. 4A and 4B show a block diagram illustrating an example process in accordance with the methods and systems described herein.

At 402, a voice query is received, for example at a client device comprising a VA. At 404, an intent of the voice query is determined, for example, at VA cloud services associated with the VA. Once the intent has been determined, at 405 a conversational application to resolve the intent of the voice query is selected, for example, at the VA cloud services.

Once the conversational application has been selected, at 406 an application query may be generated based on the voice query. For example, a follow up question may be generated. After the application query has been generated at 406, it is determined at 407 whether the query generated by the conversational application requires more private data than is typically required to achieve the intent of the voice query. Where it is determined that the query does not require more private data than is typically required to achieve the intent of the voice query (NO), it is determined at 408 if the voice query indicates that private data is required. If private data is required (YES), a bypass signal is generated 410. If the voice query does not indicate that private data is required (NO), it is determined at 412 whether a query generated by the conversational application is a private information query. If it is determined that the query is a private information query (YES), a bypass signal is generated at 410. If it is determined that the query is not a private information query (NO), it is determined at 414 whether an indication has been received from a client device that private data is required. If it is determined that an indication has been received from a client device that private data is required (YES), a bypass signal is generated 410. If it is determined that an indication has not been received from a client device that private data is required (NO), at 416 the intent of the voice query is resolved.

Once a bypass signal has been generated at 410, the type of private data is determined at 418. After the type of private data has been determined, at 420 a second communication path between a user device and the conversational application is determined based on the type of private data and bypassing the virtual assistant cloud service. The second communication channel is then established at 422. The second communication channel is encrypted at 424. At 426 interaction is enabled with the user through the second communication channel, for example, the conversational application sends the private information query to a client device which presents the request for private data to the user. Then, at 428, it is determined whether private data has been received at the conversational application. For example, it may be determined whether private data has been received from a client device. Where private data has not been received (NO), at 430 it is determined whether the request for information has timed out, for example, whether a predetermined amount of time has passed since the interaction with the user was established. Where the request has not timed out (NO), interaction with a user through the second communication channel is continued to be enabled at 426. Where the request has timed out (YES), at 432 the system reverts to providing a communication channel between the client device and the conversational application through the first communication channel. At 428, where it is determined that private data has been received at the conversational application (YES), at 416 the intent of the voice query is resolved. Once the intent of the voice query has been resolved, the system reverts to providing a communication channel between the client device and the conversational application through the first communication channel at 432.

After the application query has been generated at 406, it is determined at 407 whether the query generated by the conversational application requires more private data than is typically required to achieve the intent of the voice query. Where it is determined that the application query does require more private data than is typically required to achieve the intent of the voice query (YES), an alert is generated at 436. The alert may indicate to the user that an inappropriate amount of private data has been requested. The communication between the user and the conversational application may then revert to the first communication channel at 432.

The actions or descriptions of FIGS. 4A and 4B may be done in any suitable alternative orders or in parallel to further the purposes of this disclosure. Furthermore, it will be appreciated that any actions of FIGS. 4A and 4B may be excluded from the process.

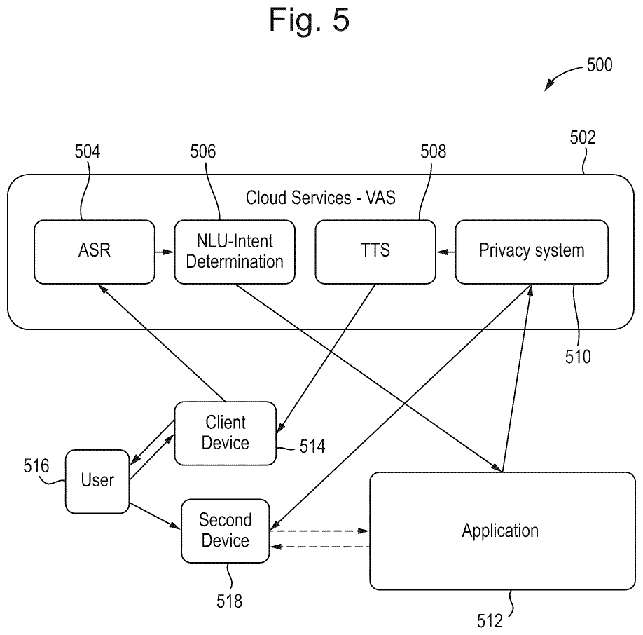

FIG. 5 is block diagram illustrating the communication between components of a system for processing voice input. An example of the difference in handling private information as opposed to non-private information is outlined below in relation to FIG. 5.

As is illustrated here, a system 500 comprises VA cloud services 502, The VA cloud services 502 of this example comprise an ASR module 504, an NLU intent determination module 506, a TTS module 508, and a privacy system 510. The system 500 further comprises a conversational application 512 communicatively coupled to the VA cloud services 502. The system further comprises a client device 514 comprising a virtual assistant and communicatively coupled to the VA cloud services 502, and a second device 518 communicatively coupled to the privacy system 510 and the conversational application 512. A user 516 may interact with the client device 514 and the second device 518. In this example, the privacy system 510 is illustrates as being a part of the VA cloud services, however, it will be appreciated that the privacy system may be provided as an entity separate from the VA cloud services, or may be incorporated into a specific VA cloud service (e.g. module).

As is generally described herein, there may be provided different communication channels for communicating different types of information (in particular, private information and non-private information). In an example, for collecting a response to a non-private information query the system may communicate with a client device through a first communication channel. For collecting responses to a private information query, (e.g., what are your symptoms, what is your SSN, what is your insurance number, etc.) the system may initiate or establish secure communication with a second device.

In an example, the user 516 gives the client device 514 a voice query (e.g., “Book me a doctor's appointment”). The client device 514 send to the ASR module 504 the voice query. The ASR module 504 performs automatic speech recognition to generate raw text. The raw text is sent from the ASR module 504 to the NLU intent determination module 506. The NLU intent determination module 506 performs natural language understanding processes to determine what the user intended by their voice query (e.g. user intent). Once the intent has been determined, an appropriate conversational application can be selected to address the query. Once a conversational application has been selected, the determined intent and the raw text are sent to the selected conversational application 512. The conversational application 512 then generates an application query based on the received information (e.g., “For which date do you want to book the appointment?”). This application query is then sent from the conversational application 512 to the privacy system 510. The privacy system 510 classifies the application query as being a non-private information query. The application query is then sent from the privacy system 510 to the TTS module 508. The TTS module 508 performs text to speech processes to generate an audio query (e.g., “For which date do you want to book the appointment?”), which is then sent from the TTS module 508 to the client device 514. The client device 514 presents the application query to the user 516 as audio. The user 516 then verbally responds to the application query. The audio response is forwarded by the client device 514 to the ASR module 504. The ASR module 504 performs automatic speech recognition to generate raw text. The raw text is sent from the ASR module 504 to the NLU intent determination module 506. The NLU intent determination module 506 forwards the raw text to the conversational application 512. The conversational application 512 then generates an application query based on the received information (e.g., “What are your symptoms?”). This application query is then sent from the conversational application 512 to the privacy system 510. The privacy system 510 classifies the application query as being a private information query. The application query is then sent from the privacy system 510 to the TTS module 508. The TTS module 508 performs text to speech processes to generate an audio query (e.g., “What are your symptoms?”), which is then sent from the TTS module 508 to the client device 514. The client device 514 presents the application query to the user 516 as audio. As this application query relates to private information, the voice used to present the application query to the user is different to a voice used to present an application query not relating to private information. A notification indicating that secure communication is initiated on a second device is sent from the privacy system 510 to the TTS module 508. The TTS module 508 performs text to speech processes to generate an audio notification, which is sent to the client device 514, where the client device 514 presents the notification to the user 516 (e.g. “Secure communication is initiated on your smartphone”). The privacy system 510 sends a custom entity recognition model for detecting disease names and initiates a secure chat interface on the second device 518. The user 516 then interacts with the second device to provide the private data (e.g., verbally, nonverbally, text input, approving sharing of pre stored private data etc.). In an example where the user approves sharing of pre-stored private data, local data corresponding to the private data may be identified on the second device, for example, using a custom entity recognition model, where the second device 518 then shares the detected entity directly with the conversational application 512. For example, the custom entity recognition model may indicate that the required private data is stored in association with a “Health” app, where key words may include “Blood type”, “Medications:” etc. The conversational application 512 then performs a function to fulfil the user's intent, using the provided private data (for example, the conversational application books the appointment). The application 512 then generates an application response (which may also be termed an application query) based on the received information (e.g., “The appointment has been booked”). This application response is then sent from the conversational application 512 to the privacy system 510. The privacy system 510 classifies the application response as being a non-private information response. The application response is then sent from the privacy system 510 to the TTS module 508. The TTS module 508 performs text to speech processes to generate an audio response (e.g., “Thank you for sharing your details, the appointment has been booked”), which is then sent from the TTS module 508 to the client device 514. The client device 514 presents the application response to the user 516 as audio.

The systems described herein may support different interactive interfaces on a device (e.g. the client device, a second device etc.) to collect private information. For example, a graphical user interface (GUI) may be used to collect private information, or the private information may be collected by selecting options or entering a user response using user voice input on the second device. For example, the conversational application may present interactive interfaces and collect private information using an application associated with the conversational application installed on a user device, a (secure) web chat interface, or through an interactive voice response (IVR) call. An application associated with the conversational application may be installed on the second device and may present follow on questions. Various conversational applications may have corresponding apps that users may install on a user device. A notification requesting access to private information may be presented to a user on the second device that has stored thereupon the required private information (e.g., DoB, SSN, Insurance ID etc.). The notification may be managed by the operating system of the second device, or by the application installed on the second device. The notification may include an approval request, for example to approve the collecting of private data stored on the second device. The user may approve or deny a sharing of pre stored information or may choose to type the required information using the notification centre interface, rather than opening an application associated with the conversational application to share the required information or allowing the conversational application to access the stored private information. The application associated with the conversational application may collect the typed information and securely share the information with the conversational application. The user may respond to a request for private information by selecting an option or options from a list presented at an interface of the second device. The list may be a personalised list relevant to a particular user.

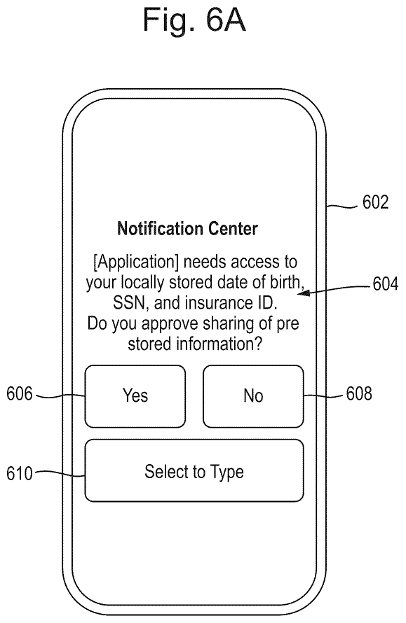

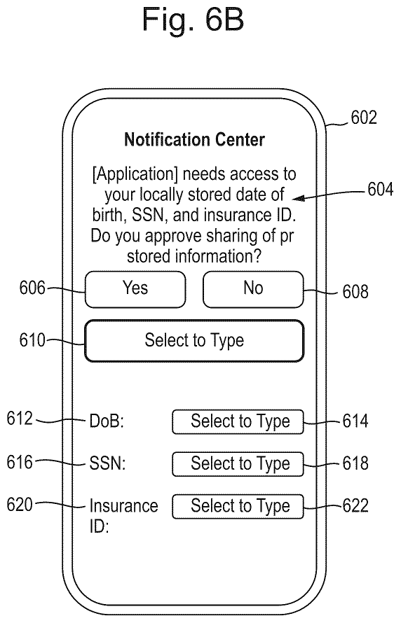

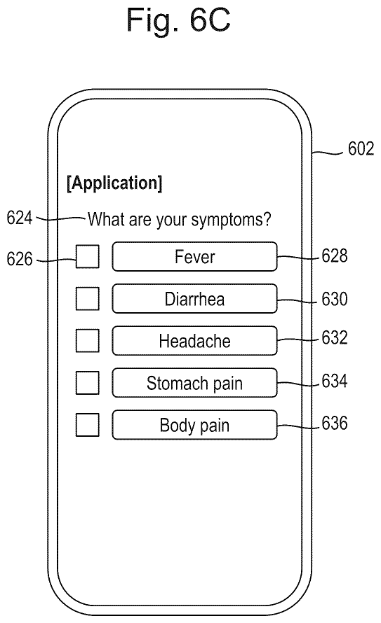

FIGS. 6A-6C illustrate examples of interactive interfaces on the second device for collecting private data.

FIG. 6A illustrates an interface requesting that a user permits sharing of pre stored private data through the an application associated with the conversational application. In particular, in this example, the second device 602 displays a notification 604 with the query “[Application] needs access to your locally stored date of birth, SSN (social security number), and insurance ID (identification). Do you approve sharing or pre stored information?”. The user may interact with the graphical user interface by selecting a button indicating either “Yes” 606, “No” 608, or “Select to Type” 610. For example, the user may confirm or deny approval for the sharing or pre stored information. Alternatively, the user may type the requested information to be shared with the application.

An example of the interface for the typing of the subset of private information is shown in FIG. 6B. For example, where user selects “Select to Type” 610, the interface may provide several options for the user to input private data by typing any of the requested private data. For example, here, the requested private data “DoB” 612 is shown alongside a text input button “Select to type” 614. Similarly, private data “SSN” 616 is shown alongside a text input button “Select to type” 618, and private data “Insurance ID” 620 is shown alongside a text input button “Select to type” 622. By selecting a button labelled “Select to type”, the user will be able to input the private information using a keyboard.

FIG. 6C illustrates an interface requesting to share private data through the application. In this case, the private data is not stored in the application, but instead it is requested of the user to input the private data. In particular, in this example, the second device 602 displays a query “What are your symptoms?” 624. Various options from which the user can select are presented below the query as a list, where a user may select a selection box 626 (e.g., tick box) next to a symptom that they are experiencing. As an example, here, the options to select are “fever” 628, “diarrhea” 630, “headache” 632, “stomach pain” 634, and “body pain” 636.

It will be appreciated that the example of FIG. 6 outlined above may equally apply to a client device having a virtual assistant, where the client device is configured to receive the private data through a means other than the virtual assistant.

In an example, rather than using an application interface, a web interface with the specific question may be prompted on the second device. The conversational application may initiate secure web chat to present the follow on questions on the second device, and the user may respond through the web interface.

In an example where the second device does not have thereupon the conversational application associated application, or the user does not wish to use the web interface, the conversational application may allow the user to share a mobile number on which the conversational application can call and collect the required information using interactive voice response (IVR). The conversational application may share with the IVR system a set of questions for which answers are required from the user to fulfil the user intent. The IVR system may present these questions one after another during an IVR call. The IVR response performed by the user may be a voice response or a touch/type response. After collecting the required data, the IVR call can be terminated, and the conversational application may send the intent fulfilment confirmation on the second device and/or to the client device through VA cloud services.

As is discussed herein, the second communication channel is established if it is determined that private data is required to resolve an intent of a voice query. To determine that private data is required to resolve an intent of a voice query, the system may analyse each query generated by a conversational application to determine if an application generated query is a “private information query”. The system may be trained to determine whether the queries are “private information queries” or “non private information queries” (e.g., normal queries).

In an example, a model may be used to determine whether queries are “private information queries” or “non private information queries”. The model may comprise any type of model, such as, for example, a model trained using a machine learning process. Examples of models that may be used herein include, but are not limited to neural network models such as deep learning neural networks and random forest models.

A neural network is a type of supervised machine learning model that, for specific input data, may be trained to predict a required output. Neural networks may be trained by providing training data comprising example input data and corresponding “correct” or ground truth outcomes that are required. Neural networks comprise a plurality of layers of neurons, each neuron representing a mathematical operation that is applied to the input data. The output of each layer in the neural network is fed into the next layer to produce an output. For each piece of training data, weights associated with the neurons are adjusted until the optimal weightings are found that produce predictions for the training examples that are consistent with the corresponding ground truths.

Although examples of neural networks are provided herein, the skilled person will appreciate that generally the trained model may comprise any model that may be trained to take as input a query and output an indication of whether the query is a “private information query” or a “non-private information query”.

In an example, the model may comprise a trained neural network, such as a trained F-net or a trained U-net. In other examples, the model may be trained using Random-Forest regression, or support-vector regression, or other non-linear regressor. In an example, the model may comprise a decision tree or a random forest model. The model may comprise a classification model, or a regression model.

In order to train the model, predefined exemplary queries which may be considered to be “private information queries” may be labelled as such and input to the model for training. A training data set to be input to the model may be prepared by tagging sensitive, or private, information along with the type of sensitive, or private, information in historical user responses (e.g., stored prior responses of a user or users). For example, in the cases above where the user indicates that data to be shared is private data, the query that has caused the user to make the indication may be stored along with an indication that the query is a “private information query”. In a further example, an action of a user (e.g. in response to a query) may be used to determine whether a query is a “private information query”. For example, if a user typically abandons a conversation session every time a particular query is raised (for example. “Are you currently being treated for disease x”), that query is likely to be perceived as being private in nature, and may be tagged as a private information query. Queries presented to a user where the response from the user comprised sensitive information may be tagged as a “private information query”. These private information queries may be used for training the model. Non-private information queries may be tagged as “non-private information queries” and may also be used to train the model.

Table 1 illustrates an exemplary representation of a training data set.

TABLE 1

| Query | Label |
|---|---|
| Book a doctor's appointment. | Private |
| For which date do you want to book the | Non-Private |
| doctor's appointment? | |
| What are your symptoms? | Private |
| Book a table at the nearest restaurant. | Non-Private |
| What is your social security number? | Private |
| What is your driver's license number? | Private |
| Play me a song. | Non-Private |
| Are you on any prescription drugs? | Private |
| Turn on the lights in this room. | Non-Private |

The private information queries may be classified into different categories depending on the type of sensitive information that each of these queries has the potential to collect. Queries that have the potential to collect a particular type of sensitive information can be grouped together to create a question category or a sub category.

Table 2 illustrates an exemplary representation of the information type and associated queries.

TABLE 2

| Sensitive Information | |
|---|---|
| Type | Example |
| Personal Information (PI) | name, DoB, Location, Racial or Ethnic Origin, |
| | political affiliation. |
| Personally identifiable | SSN, Driver's license no, State ID no., |
| information | passport number, account login, etc. |
| Sensitive Perform | SSN, Driver's license no, State Identification |
| Information (SPI) | no., passport number, account login, access |
| | code, etc. |
| Non-Public Personal | Name, address, phone number, SSN, Bank ac |
| Information | number, cc number, etc. |
| Material Non Public | Corporate information, earning report, |
| Information | corporate plan, etc |
| Private Information | Biometric information, CC no., access code, |
| | password, etc. |
| Person Health | Health Record ID, diseases, symptom, health |
| Information | parameters etc. |

The system may maintain a dynamically updated list of private information queries which may assist in recognising and flagging a real time skill generated query as a “private information query”. The system may check if a conversational application generated response matches a question category such as those outlined in table 2, where if a match is found call mom the skill generated response is marked as a “private fetching query” and a bypass signal may be generated accordingly.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, using control circuitry, a voice query at a virtual assistant cloud service through a first communication channel;
determining, using control circuitry, an intent of the voice query at the virtual assistant cloud service;
selecting, using control circuitry, an application to resolve the intent of the voice query;
determining, using control circuitry, whether private data is required to resolve the intent of the voice query; and, where private data is required to resolve the intent of the voice query,
establishing, using control circuitry, a second communication channel for receiving the private data at the application.

2. The method of claim 1, wherein the second communication channel bypasses the virtual assistant cloud service.

3. The method of claim 1, wherein the second communication channel is established based on a bypass signal generated by the application or by the virtual assistant cloud service, or based on a user initiated bypass signal.

4. The method of claim 1, wherein the second communication channel comprises a path between:
a first device comprising a virtual assistant associated with the virtual assistant cloud service, or a second device; and
at least one of: the application, a further application associated with the application, a website interface, and an interactive voice response.

5. The method of claim 1, wherein the second communication channel is an encrypted communication channel.

6. The method of claim 1, wherein the pathway of the second communication channel is dependent on the type of private data.

7. The method of claim 1, wherein the determination that private data is required is made based on at least one of: a determination that a query generated by the application is a private information query; a determination that the voice query indicates that private data is required; receiving an indication from a client device that private data is required.

8. The method of claim 1, further comprising receiving private data at the application via the second communication channel.

9. The method of claim 1, further comprising reverting to the first communication channel once the receiving of private data is concluded or a predetermined time period has elapsed.

10. The method of claim 1, wherein the method further comprises generating an alert if a query generated by the application requires more private data than is typically required to achieve the intent of the voice query.

11. A system comprising control circuitry configured to:
receive, using control circuitry, a voice query at a virtual assistant cloud service through a first communication channel;
determine, using control circuitry, an intent of the voice query at the virtual assistant cloud service;
select, using control circuitry, an application to resolve the intent of the voice query;
determine, using control circuitry, whether private data is required to resolve the intent of the voice query; and, where private data is required to resolve the intent of the voice query,
establish, using control circuitry, a second communication channel for receiving the private data at the application.

12. The system of claim 11, wherein the second communication channel bypasses the virtual assistant cloud service.

13. The system of claim 11, wherein the second communication channel is established based on a bypass signal generated by the application or by the virtual assistant cloud service, or based on a user initiated bypass signal.

14. The system of claim 11, wherein the second communication channel comprises a path between:
a first device comprising a virtual assistant associated with the virtual assistant cloud service, or a second device; and
at least one of: the application, a further application associated with the application, a website interface, and an interactive voice response.

15. The system of claim 11, wherein the second communication channel is an encrypted communication channel.

16. The system of claim 11, wherein the pathway of the second communication channel is dependent on the type of private data.

17. The system of claim 11, wherein the determination that private data is required is made based on at least one of: a determination that a query generated by the application is a private information query; a determination that the voice query indicates that private data is required; receiving an indication from a client device that private data is required.

18. The system of claim 11, the system further configured to receive private data at the application via the second communication channel.

19. The system of claim 11, the system further configured to revert to the first communication channel once the receiving of private data is concluded or a predetermined time period has elapsed.

20. The system of claim 11, wherein the system is further configured to generate an alert if a query generated by the application requires more private data than is typically required to achieve the intent of the voice query.

21.-50. (canceled)
